(19) United States
(12) Patent Application Publication
(10) Pub. No.: US 2011/0175465 A1
(43) Pub. Date: Jul. 21, 2011

(54) GEARBOX DRIVE UNIT

(75) Inventors: Thomas Huck, Rheinmuenster (DE); Lars-Dirk Anding, Nagold (DE)

(73) Assignee: ROBERT BOSCH GMBH, Stuttgart (DE)

(21) Appl. No.: 13/059,436

(22) PCT Filed: Jul. 15, 2009
(86) PCT No.: PCT/EP2009/059033

§ 371 Date: Apr. 5, 2011

(30) Foreign Application Priority Data
Aug. 22, 2008 (DE) 102008041443.3

(51) Int. Cl. H02K 1/04

(52) U.S. Cl. 310/43

(57) ABSTRACT

The invention relates to a gearbox drive unit (2), particularly for adjusting moving parts in a motor vehicle, comprising a gearbox housing (1), in which an output gear is rotatably supported on a bearing axle (4) extending perpendicular relative to a housing bottom (13). According to the invention, the bearing axle (4) is designed at least in sections as, at least in sections, a hollow metal bolt and/or as a multi-part, combined plastic/metal axle.

### BACKGROUND OF THE INVENTION

The invention relates to a gearbox drive unit, particularly for adjusting moving parts in a motor vehicle, preferably for adjusting a motor vehicle window.

DE 1 149 463 A1 has disclosed a gearbox drive unit in which an output wheel is arranged rotatably on a solid bearing pin made from plastic and fixed with respect to the housing. For some applications, the strength of the plastic bearing pin is in need of improvement.

For this reason, gearbox drive units have been disclosed which have a bearing pin made of solid metal for supporting the output wheel of the drive/gearbox unit. In this arrangement, the high weight and the high costs for the production of the bearing pin from solid material, especially, are disadvantageous.

### SUMMARY OF THE INVENTION

The problem underlying the invention is to propose a drive/gearbox unit which is optimized for cost and weight while having adequate strength.

The invention follows two approaches to a solution for ensuring adequate strength of the bearing spindle and/or of the connection between the bearing spindle and the gearbox housing while simultaneously minimizing weight and production costs, and these approaches can be implemented separately or, preferably, in combination. Thus, the invention proposes a gearbox drive unit in which the bearing spindle is designed sectionally or completely as a metal pin which, for the sake of saving materials and weight, is internally hollow, at least sectionally, and is preferably designed as a hollow cylinder. As an additional or alternative means of reducing the weight of the gearbox drive unit, a multi-part, in particular two-part, bearing spindle composed of a plastic/metal combination of materials can be implemented, the metal part serving essentially to ensure adequate strength and the plastic part serving essentially a weight- and cost-reducing function. It is particularly preferred if the metal part—of which there is at least one and preferably just one—of the combined plastic/metal spindle is designed sectionally or completely as a hollow metal pin, in particular as a hollow cylinder, in order to further minimize the weight.

An embodiment of the gearbox drive unit in which the output wheel, which is preferably designed as a worm wheel, is designed as a combined output/driver wheel with an integrated driver portion for driving a customer-specific application, preferably a Bowden cable for a window lifter drive, is very particularly preferred. In other words, it is preferred that the output unit, which is otherwise of multi-part construction, comprising an output wheel, damping elements and a driver, be designed as a one-piece output wheel, i.e. that the output wheel be equipped with means for direct torque transmission and with integral damping means.

As a development of the invention, it is advantageous to make provision for either the entire bearing spindle or part of the bearing spindle of a combined plastic/metal spindle to be of hollow design throughout, i.e. tubular, or for the bearing spindle or part of the bearing spindle to have at one end or at both ends a blind opening, preferably a blind bore, extending in the axial direction.

As a development of the invention, it is advantageous to make provision for the bearing spindle to be designed, in the region of the free end thereof, as an interface for fixing an end-user application, in particular a customer-specific end-user application. For this purpose, the bearing spindle preferably has positive-locking means and/or a thread etc. It is advantageous if a blind opening arranged in the region of a free end of the bearing spindle is formed for the purpose of fixing a customer-specific application, in particular a Bowden cable mechanism.

If the bearing spindle is designed as a combined plastic/metal spindle, it is preferred if the bearing spindle is embodied in two parts and has a plastic bottom part and a metal top part, which is preferably in the form of a pin or, at least sectionally, a hollow cylinder. In this way, it is possible to guarantee the required strength values for fixing a customer-specific application in the region of the free end of the bearing spindle.

It is particularly preferred if the plastic bottom part is formed by a gearbox housing extension, i.e. if the plastic bottom part of the bearing spindle is of one-piece design with the gearbox housing of the gearbox drive unit, said housing preferably being manufactured from plastic.

It is particularly preferred if the housing extension, which extends in the axial direction in relation to the bearing spindle, takes the form of a housing dome of internally hollow design, in the region of the free end of which the metal top part of the bearing spindle is fixed.

It is possible to implement an embodiment of the gearbox drive unit in which the output wheel is rotatably supported both on the plastic bottom part and on the metal top part. However, an embodiment in which the output wheel is supported exclusively on the plastic bottom part or at least to a large extent on the plastic bottom part and only negligibly, if at all, on the metal part of the bearing spindle passing through the output wheel, is particularly preferred.

As a development of the invention, it is advantageous if provision is made for the metal top part of the bearing spindle of two-part plastic and metal design to be fixed positively on the plastic bottom part. It is particularly preferred in this context if the metal top part is connected to the plastic bottom part and hence preferably to the gearbox housing by overmolding with plastic. It is thus possible to implement fixing by injection molding in a joint working step with the production of the gearbox housing.

An embodiment in which the metal top part of the combined bearing spindle composed of plastic and metal has a lower blind opening which opens into a hollow space delimited radially on the outside by the housing dome or plastic bottom part of the two-part bearing spindle, thereby optimizing the weight saving and saving of materials in the gearbox drive unit, is particularly preferred.

### BRIEF DESCRIPTION OF THE DRAWINGS

Further advantages, features and details of the invention will become apparent from the following description of preferred illustrative embodiments and with reference to the drawings, in which:

FIG. 1 shows a schematic sectioned representation of a gearbox drive unit with a two-part plastic/metal bearing spindle,

FIG. 2 shows a schematic sectioned representation of a gearbox drive unit with a bearing spindle made from metal, which has a blind opening in the region of the free end thereof,

FIG. 3 shows a schematic sectioned representation of a gearbox drive unit with a two-part bearing spindle, the metal part of which has two diametrically opposite blind openings, and

FIG. 4 shows a schematic sectioned representation of a gearbox drive unit with a hollow-cylindrical bearing spindle made of metal.

### DETAILED DESCRIPTION

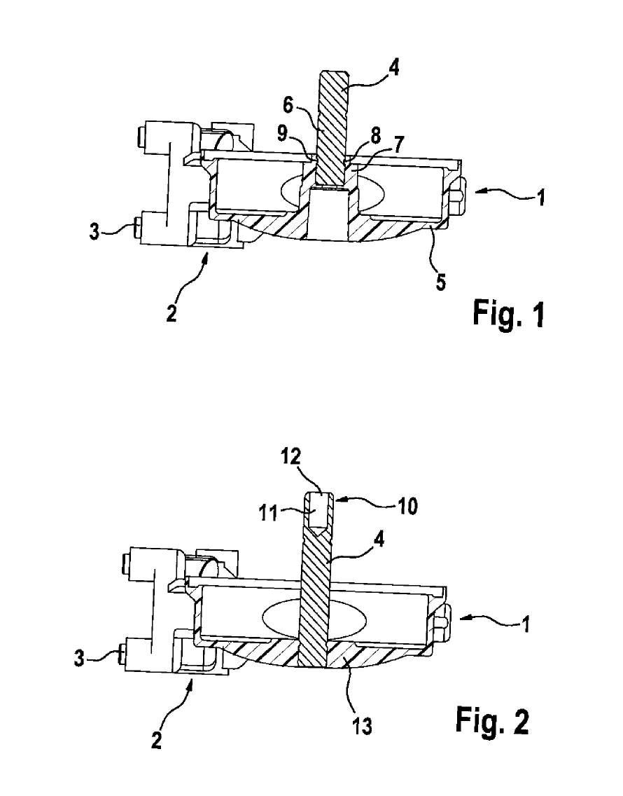

In FIG. 1, a plastic gearbox housing 1 of a gearbox drive unit 2 for adjusting a motor vehicle window is illustrated in a sectioned view. The gearbox housing 1 comprises a lateral fixing flange 3 for fixing a pole housing (not shown) of an electric motor (likewise not shown) of the gearbox drive unit 2 for driving an output wheel (not shown) designed as a worm wheel that can be supported rotatably on a bearing spindle 4. In this arrangement, the output wheel is coupled in a torque-transmitting manner to the electric motor by means of a transmission worm seated non-rotatably on the armature shaft.

A trough-shaped portion 5 of the gearbox housing 1, said portion having substantially circular contours, for holding the output wheel designed as a worm wheel can be seen. Situated centrally in this portion 5 is the bearing spindle 4, which, in the illustrative embodiment shown in FIG. 1, is of two-part design and comprises a pin-shaped metal top part 6 and a plastic bottom part 7. The plastic bottom part 7 is of one-piece design with the gearbox housing 1 and is formed by a dome-type extension of the gearbox housing 1, said extension having a through opening, that is to say being internally hollow. In the embodiment of a gearbox drive unit 2 shown in FIG. 1, the output wheel is supported exclusively on the plastic bottom part 7, whereas the metal top part 6, which is designed as a bearing pin made of solid material, merely has the function of holding a customer-specific application and/or supporting a driver coupled in a torque-transmitting manner to the output wheel.

As is apparent from FIG. 1, the pin-shaped metal top part 6 is connected positively to the plastic bottom part 7 of the bearing spindle 4. In the illustrative embodiment shown, the metal top part 6 is fixed on the plastic bottom part 7 by overmolding, and the plastic bottom part 7 engages non-detachably, by means of a radially inward-pointing annular extension 8, into a corresponding circumferential groove 9 on the outer circumference of the metal top part 6 of the bearing spindle 4.

In the illustrative embodiment shown in FIG. 2, the bearing spindle 4 is embodied as a one-piece metal pin, and a blind opening 11 embodied as a blind bore is made at the end of the bearing spindle 4 in the region of the free end 10 thereof. This opening serves, on the one hand, as an interface for the fixing of a customer-specific application (not shown), for which purpose the blind opening 11 is provided with an internal thread, for example. However, the essential function of the blind opening 11 is to reduce the weight of the bearing spindle 4 and hence of the entire gearbox drive unit 2 while simultaneously ensuring adequate strength. As is apparent from FIG. 2, the bearing spindle 4, which is designed as a metal pin, is fixed positively in a housing bottom 13 of the gearbox housing 1 by overmolding.

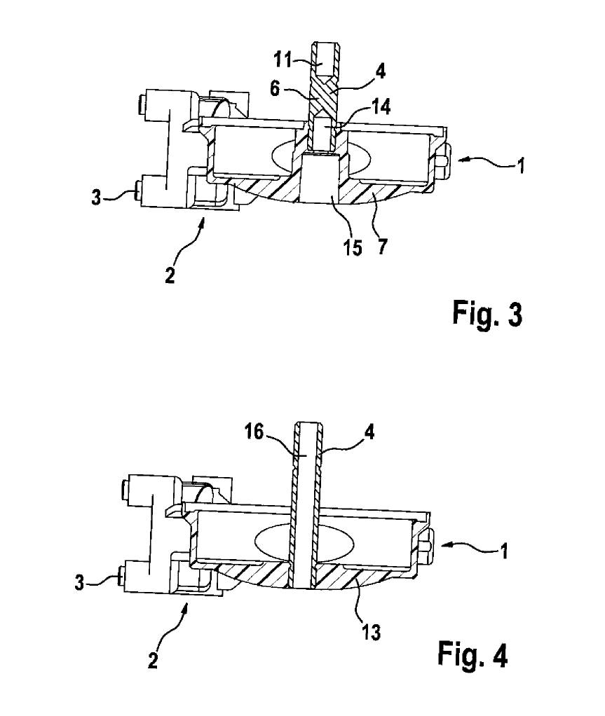

The illustrative embodiment shown in FIG. 3 corresponds substantially to the illustrative embodiment shown in FIG. 1, with the single difference that the metal top part 6 of the combined plastic/metal bearing spindle 4 is not designed as a pin made of solid metal but as a sectionally hollow metal pin with two blind openings 11, 14 situated at opposite ends, the blind opening 14 situated at the bottom in the plane of the drawing opening into a hollow space 15 delimited radially on the outside by the plastic bottom part 7 of the two-part bearing spindle 4.

The illustrative embodiment shown in FIG. 4 corresponds substantially to the illustrative embodiment shown in FIG. 2, with the single difference that the bearing spindle 4, which is made completely of metal, is provided with a through opening 16, giving a tubular, hollow-cylindrical configuration of the bearing spindle 4 and hence optimized weight reduction combined with adequate strength values. As with the illustrative embodiment shown in FIG. 2, the bearing spindle 4 designed as a metal pin is fixed positively in the housing bottom 13 of the gearbox housing 1 of the gearbox drive unit 2 by overmolding.

1. A gearbox drive unit comprising a gearbox housing (1), in which an output wheel is rotatably supported on a bearing spindle (4) extending perpendicularly relative to a housing bottom (13), characterized in that the bearing spindle (4) is at least one of formed at least partially of a metal pin that is at least partially hollow, and formed as a multi-part, combined plastic and metal spindle.

2. The gearbox drive unit as claimed in claim 1, characterized in that the bearing spindle (4) is hollow throughout.

3. The gearbox drive unit as claimed in claim 1, characterized in that the bearing spindle (4) is designed, in a region of a free end (10) thereof, as an interface for fixing an end-user application.

4. The gearbox drive unit as claimed in claim 1, characterized in that the bearing spindle (4) has a plastic bottom part (7), and a metal top part (6) adjoining the plastic bottom part (7).

5. The gearbox drive unit as claimed in claim 4, characterized in that the plastic bottom part (7) is formed by a gearbox housing extension.

6. The gearbox drive unit as claimed in claim 5, characterized in that the housing extension is designed as a housing dome of internally hollow design.

7. The gearbox drive unit as claimed in claim 4, characterized in that the output wheel is rotatably supported on the plastic bottom part (7).

8. The gearbox drive unit as claimed in claim 4, characterized in that the metal top part (6) is fixed positively on the plastic bottom part (7).

9. The gearbox drive unit as claimed in claim 8, characterized in that the metal top part (6) is fixed on the plastic bottom part (7) by overmolding with plastic.

10. The gearbox drive unit as claimed in claim 6, characterized in that a lower blind opening (14) of the metal top part (6) opens into a hollow space (15) delimited partially by the housing dome.

11. The gearbox drive unit as claimed in claim 1, characterized in that the bearing spindle has a blind bore (11) at at least one end.

12. The gearbox drive unit as claimed in claim 11, characterized in that the bearing spindle has a blind bore (11) at both ends.

13. The gearbox drive unit as claimed in claim 7, characterized in that the output wheel is rotatably supported exclusively on the plastic bottom part (7).

14. The gearbox drive unit as claimed in claim 1, characterized in that the bearing spindle is formed at least partially of a metal pin that is at least partially hollow.

15. The gearbox drive unit as claimed in claim 14, characterized in that the metal pin is hollow throughout.

16. The gearbox drive unit as claimed in claim 14, characterized in that the metal pin has a blind bore (11) at at least one end.

17. The gearbox drive unit as claimed in claim 14, characterized in that the metal pin has a blind bore (11) at both ends.

18. The gearbox drive unit as claimed in claim 1, characterized in that the bearing spindle is formed as a multi-part, combined plastic and metal spindle.

19. The gearbox drive unit as claimed in claim 19, characterized in that the metal part of the bearing spindle is the metal pin.

20. The gearbox drive unit as claimed in claim 4, wherein the metal top part includes the metal pin.
